(19) United States
(12) Patent Application Publication
(10) Pub. No.: US 2022/0379457 A1
(43) Pub. Date: Dec. 1, 2022

(54) Improved Self-Balancing Tool Guide

(71) Applicant: Hilti Aktiengesellschaft, Schaan (LI)

(72) Inventors: Dario BRALLA, Buchs (CH); Peer SCHMIDT, Lindau (DE)

(21) Appl. No.: 17/775,209

(22) PCT Filed: Nov. 6, 2020
(86) PCT No.: PCT/EP2020/081293

§ 371 Date: May 6, 2022

(30) Foreign Application Priority Data
Nov. 15, 2019 (EP) 19209470.4

(51) Int. Cl. B25H 1/00

(52) U.S. Cl. CPC B25H 1/0028; B25H 1/0035

(57) ABSTRACT

A self-aligning tool guide includes a mounting for fixing a hand-held machine tool, a lifting mechanism where the mounting is mounted on the lifting mechanism, and a self-balancing chassis that has two wheels on a wheel axle, a drive coupled with the two wheels, and a steering system. A lateral deflection of a center of gravity of the lifting mechanism relative to the wheel axle is detectable by a center of gravity sensor and the steering system is configured to control the drive to output a torque counteracting the lateral deflection. A self-balancing member is mounted on an upper portion of the self-aligning tool guide and the self-balancing member delivers an additional torque for balancing the self-aligning tool guide.

### BACKGROUND AND SUMMARY OF THE INVENTION

The invention relates to an improved self-balancing tool guide for the tool.

Suspended ceilings are a common design element in large buildings, especially in industrial and office buildings. Technical installations, such as electrical installations, ventilation systems, lighting and sound insulation, can be laid between the ceiling of the shell construction and the suspended ceiling and are accessible for subsequent inspection and maintenance. Load-bearing substructures of the installations and the suspended ceiling are fixed with dowels, screws or similar elements anchored in the ceiling of the shell construction. To build the suspended ceiling, holes are drilled in the ceiling of the shell, in which the dowels can be used or the screws can be screwed. A lateral position of the holes is predetermined by the supporting substructure.

Drilling the holes is time consuming. The user can reach the high-hanging ceiling of the shell construction only with a ladder or scaffolding. The ladder must be placed below the predetermined position, the user climbs up the ladder, drills the hole, descends the ladder, and shifts the ladder to the next position.

DE 33 28 582 A1 describes a mobile ceiling drilling and mounting device for the installation of knock-in anchors in a ceiling. The ceiling drill is based on an impact drill, which is mounted on a telescopic column. The telescopic column is suspended oscillating on a trolley. The user can drive the ceiling drill below a desired location, apply the impact drill to the ceiling by means of the column and drill a hole in the ceiling. The impact drill can be controlled via a control cabinet. For transporting over stairwells, the device must be divided into four parts—carriage, telescopic column, impact drill and control cabinet.

WO2019101482 A1 describes a self-aligning tool guide. The tool guide has a mounting, a lifting mechanism and a chassis. The self-aligning tool guide allows for a very compact and lightweight design by reducing the number of assemblies. The axis of the tool is aligned by the drive control and wheels. In a deflection of the tool from the predetermined direction, the wheels actively exert a counter-torque, which aligns the tool correctly again. This is especially necessary when applying the tool to the ceiling. The dynamic stabilization enables a stable footing of the tool guide already on one wheel or on two wheels. However, such a tool guide system usually is quite high, almost reaching to the ceiling, it is unstable either in driving mode or standing mode. The position of the tool guide system sometimes cannot be very accurately as expected. Also, if the tool guide system moves too fast, there would be highly possible to fall down due to its high gravity center. Therefore, it is necessary to improve the stability, increase the accuracy of the positioning and moving speed.

Accordingly, the primary object of the present invention is to provide an improved self-aligning tool guide. for anchorage in a bore hole that can be used also for heavy loads, that can perfectly balance three functions of the collapsible function, the anti-spinning and setting functions.

An embodiment of the invention relates to an improved self-aligning tool guide. The tool guide has a mounting, a lifting mechanism and a self-balancing chassis. The mounting is for fixing a hand-held machine tool. The mounting is mounted on the lifting mechanism. The lifting mechanism has a propulsion unit for vertical lifting of the mounting. The self-balancing chassis has two wheels on a wheel axle, a drive coupled with the wheels and a steering system. A center of gravity sensor is mounted to detect a lateral deflection of the center of gravity of the lifting mechanism relative to the wheel axle. The steering is set up to control the drive, to output a torque counteracting the deflection (x). An additional self-balancing member is mounted on the upper portion of the tool guide to deliver an additional torque for balancing the tool guide.

In one embodiment, the additional self-balancing member calculates the additional torque compensatory counteracting the deflection complementarily. Preferably, the additional self-balancing member creates the additional torque applying to the wheels.

The axis of the tool is aligned by the drive control and wheels. In a deflection of the tool from the predetermined direction, the wheels were controlled by the drive, and actively exert a counter-torque, which aligns the tool correctly again. The additional self-balancing member work together with the drive, in a deflection of the tool from the predetermined direction, especially an accuracy of the position or moving is needed, the additional self-balancing member actively detect the deflection, and calculate a target additional torque for counteracting the deflection complementarily, then exert the additional counter-torque on upper portion of the tool guide, which aligns the tool correctly again with no movement of the wheels. The dynamic stabilization enables a stable footing of the tool guide already on wheels.

This is especially necessary when applying the tool to the ceiling. Both floor and ceiling of a shell are wavy and inclined to the horizontal, whereby lateral forces act on the tool. A freely oscillating tool would avoid the lateral forces by a deflection and thus lead to a misalignment of the tool.

In one embodiment, the additional self-balancing member holds the upper part of the tool guide in upright position. The tool guide usually touches the ground only with the two wheels. An upright standing position is ensured by the additional balancing member. The additional self-balancing member creates an additional force (leading to a counteracting torque), apply this additional torque on top of the tool guide, which can hold the tool guide in upright position, to increase the stability.

In another embodiment the additional torque created by the additional self-balancing member accelerated the tool guide's movement in a desired direction. Since the additional torque on the top enables the device to lean fast in a desired direction, which is needed to move forward. It is useful for being able to move fast. Therefore, the tool guide improves the accuracy of speed and position when it works.

In another yet embodiment, preferably, the additional self-balancing member is a propeller. Also, the additional self-balancing member can be a moving mass or compressed air. Anything which can creates force/torque on the upper portion of the tool guide can be used. The self-aligning tool guide allows for a very compact and lightweight design.

The following description explains the invention with reference to exemplary embodiments and figures.

### BRIEF DESCRIPTION OF THE DRAWINGS

FIG. 1 shows a self-aligning tool guide from the front;

FIG. 2 shows a self-aligning tool guide in a sectional view I-I;

FIG. 3 shows a self-aligning tool guide when machining a ceiling in a sectional view II;

FIG. 4 shows a status diagram;

FIG. 5 shows a diagram explaining the alignment (equilibrium);

FIG. 6 shows a diagram explaining the alignment in the forward/backward direction;

FIG. 7 shows a diagram explaining the alignment in the transverse direction;

FIG. 8 shows a diagram explaining the alignment in the transverse direction; and

FIG. 9 shows a status diagram.

### DETAILED DESCRIPTION OF THE DRAWINGS

Identical or functionally identical elements are indicated by the same reference numerals in the figures, unless stated otherwise. Vertical, in the context of this description, denotes a direction parallel to gravity; horizontal denotes a direction or plane perpendicular to gravity.

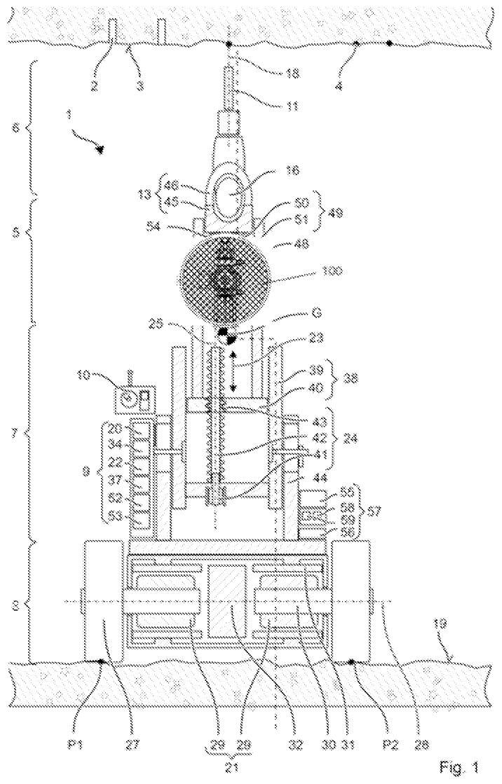

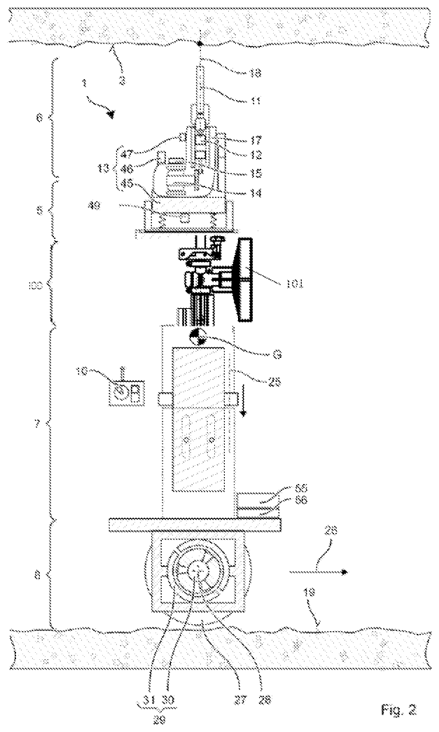

FIG. 1 to FIG. 3 show an exemplary improved self-aligning tool guide 1 for installation work in a shell construction. An assembly of a ventilation pipe requires, for example, several holes 2 in a ceiling 3 of the shell construction. The holes 2 should lie at predetermined positions 4, e.g., in alignment. Furthermore, the holes 2 should be parallel to each other, for example oriented vertically. Position 4 is entered in a plan, for example. A foreman can mark the position 4 by color markings on the ceiling 3 of the shell construction. Other installation work on the ceiling 3 may include setting nails, driving in screws, grinding, etc.

FIG. 1 to FIG. 3 schematically show an embodiment of the improved self-aligning tool guide 1 The tool guide 1 has a mounting 5 for a hand-held machine tool 6, a motorized lifting mechanism 7, a motorized chassis 8, a controller 9, a console 10 and an additional self-balancing member 100. As described in the cited patent application document WO2019/101482, the user can set up the tool guide 1 with a suitable hand-held machine tool 6 and a suitable tool 11 according to the application. For drilling holes 2 in a shell construction this would be, for example, an impact drill with a hammer mechanism 12 and a drill with a sintered carbide tip. The hand-held machine tool 6 can be used in the mounting 5 on the lifting mechanism 7. A lock 13 secures the hand-held machine tool 6 in the mounting 5. The lock 13 is preferably releasable without tools. In other embodiments, the power tool with the mounting may be 5 be permanently connected, for example, it may be screwed.

The impact drill is just one example of a hand-held machine tool 6. Other examples are an electric screwdriver, a nail setter, an angle grinder, a glue gun, a paint spray gun, etc. One type of hand-held machine tool 6 drives a replaceable tool 11, e.g., the drill, a chisel, a screwdriver bit, a cutting disc, etc., for its function. Another type of hand-held machine tool 6 directly processes a consumable, e.g., nails, screws, paint, glue. The hand-held machine tools 6 are characterized by an own drive, with which the tool 11 is driven or the consumable is driven or applied. The user does not have to apply manual force for the use of the hand-held machine tool 6. The hand-held machine tools are referred to as power tools. The power source 14 may be electric or fuel-driven. Examples are an electric motor, an electric pump, a gas-fed combustion chamber, a powder-driven piston, etc. The power source 14 is coupled to a (trigger) button 15. When the trigger button 15 is pressed, the power source 14 is activated. The trigger button 15 is preferably remotely triggered or locked.

The hand-held machine tool 6 may be a commercially available hand-held machine tool 6. The hand-held machine tool 6 has a handle 16 and typically a housing portion 17 for fastening an additional handle. The hand-held machine tool 6 may be formed without a handle. The mounting 5 may also be designed for non-handheld machine tools.

The hand-held machine tool 6 has a working axis 18 defined by its structure A tip of the tool 11 or a tip of the consumable lies on the working axis 18 The tip is moved along the working axis 18. The tip first touches the surface to be machined, e.g., the ceiling 3.

An additional self-balancing member 100 is mounted on the upper portion of the tool guide. For example, the additional member 100 could be mounted between the mounting 5 and the lifting mechanism 7. Preferably, the additional self-balancing member is connected to the lifting mechanism and can move along a fixed lifting axis 25 when the lifting mechanism 7 raises or lowers the mounting 5. Preferably, the additional balancing member is rigidly connected to the top of the lifting mechanism 7. The additional self-balancing member 100 can create an additional force (leading to a torque) on upper part of the tool guide 1, exert the torque on the wheels. This additional self-balancing member 100 can hold the tool guide 1 in the upright position, which is needed to increase the stability. It is also useful for being able to move fast.

Preferably, the additional self-balancing member 100 is a propeller 101. Alternatively, it also can be a moving mass or compressed air. Another example of the additional self-balancing member is a reaction wheel. Generally, anything which creates force/torque on top can be used. In one exemplary embodiment, the propeller 101 is rigidly connected to the tool guide 1, between the mounting 5 and the lifting mechanism 7. Also, the propeller 101 is electronically connected to the steering system 20. As it is well known, the propeller can create a force when it is activated.

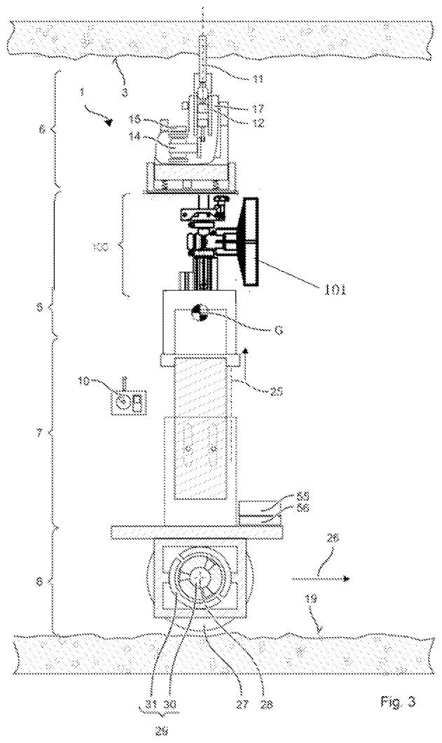

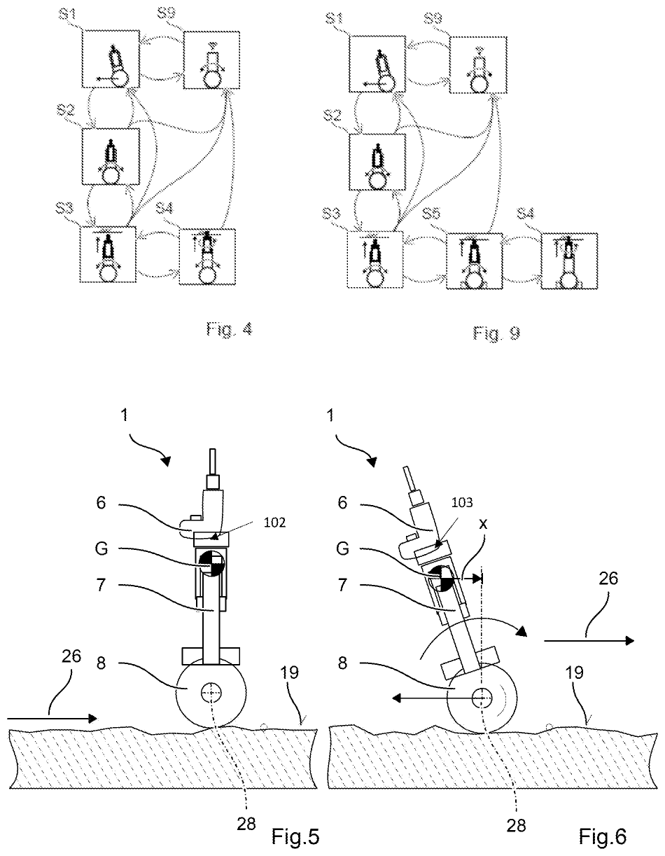

A status diagram of the tool guide 1 is shown in FIG. 4. The user activates the tool guide 1 by means of the console 10. The chassis 8 is in a (driving) mode S1 in which the user can move the tool guide 1 through the room on the floor 19. The controller 9 activates a steering system 20 of the tool guide 1. The user can set the direction of travel and speed via the console 10. The user steers the tool guide 1 to one of the marked positions 4. The chassis 8 has a drive 21 which moves the chassis 8 over the ground 19 on its own power. Direction and speed of movement of the chassis 8 are controlled by the steering system 20 of the tool guide 1. However, the positioning accuracy and speed that can be reached by controlling the steering system 20 is limited. Therefore, beside of the steering system 20, the propeller 101 is also activated by the controller and creates an additional force leading to an additional torque, then exert the correct target torque to the wheels 27. This is useful for being able to move fast, since the torque on top enables the device to lean fast in a desired direction, which is needed to move forward.

At the marked position 4 the user stops the tool guide 1. Via the console 10, the user puts the chassis 8 in a (standing) mode S2. The controller 9 locks the steering system 20 for the user or deactivates the steering system 20. The steering system 20 ignores specifications for speed and direction of travel via the console 10. The tool guide 1 remains in the currently occupied position 4. The steering system 20 can detect the current position 4. If the chassis 8 leaves the current position 4 or is shifted from this, the steering system 20 automatically generates control signals to drive the chassis 8 back to the detected position 4. In a (standing) mode S2, the propeller 101 also help the chassis 8 hole the whole device of tool guide 1 in upright position. If a sensor detects there is any deflection or deviation between the tool guide 1 and the marked position 4, the propeller 101 is activated, and then calculate a target torque needed for complementarily counteracting the deflection or deviation, exert the torque on the wheels 27, thereby holding the tool guide in the exactly correct position in upright direction allowing no movements of the wheels 27.

The user can activate a (lifting) mode S3 via the console 10 in order to lift the hand-held machine tool 6 with the lifting mechanism 7. The controller 9 forces the standing mode S2 for the chassis 8 before the lift mode can be activated. The controller 9 can delay the activation of the lift mode until the chassis 8 is stationary. In the lifting mode, a control station 22 is enabled or activated for the user. The user can specify movement direction 23 i.e., up or down, lifting speed and position of the lifting mechanism 7 via the console 10. The mounting 5 is moved by the lifting mechanism 7 accordingly. The control station 22 controls a propulsion unit 24 of the lifting mechanism 7, taking into account the predetermined vertical direction of movement and lifting speed specified via the console 10. The lifting mechanism 7 raises or lowers the mounting 5 and, optionally, the hand-held machine tool 6 inserted therein, along a fixed lifting axis 25. The lifting mechanism 7 is limited to a single-axis, translational motion on the lifting axis 25. In one embodiment, the propeller 101 is rigidly connected to the top of the lifting mechanism 7. Therefore, the propeller 101 would create different torque applying to the wheels 27 depending on the moving of the lifting mechanism 7.

The working axis 18 of the hand-held machine tool 6 is parallel to the lifting axis 25. In one embodiment, the construction of the mounting 5 forces the parallel alignment. The hand-held machine tool 6 can be used, for example, due to a fit of the mounting 5 to a housing of the hand-held machine tool 6, in only one defined manner in the mounting 5. In one embodiment, the mounting 5 can be pivoted about the (pivot) axis 25 inclined to the lifting axis, in order to align the alignment of the work axis 18 to the lifting axis 25.

An alignment of the lifting axis 25 and thus the working axis 18 relative to the ceiling 3 is done dynamically by the chassis 8 and the additional balancing member 100. The chassis 8 aligns the lifting axis 25 vertically, i.e., parallel to gravity.

The hand-held machine tool 6 can preferably switch on the control console 22. The tool 11 can machine the ceiling 3, for example, drill a hole 2. The controller 9 may have a (machining) mode S4, which automatically controls the propulsion unit 24 of the lifting mechanism 7 during the work on the ceiling 3. The machining mode can be activated manually, for example, on the console 10. In the processing mode, the control station 22 adapts the lifting speed of the lifting mechanism 7 to a machining progress of the tool 11. The lifting mechanism 7 and the tool 11 can be protected from excessive loads. A machining target, e.g., a hole depth, can be specified on the control station 22. After reaching the machining target, the control console 22 can automatically stop the propulsion unit 24. In addition, the control console 22 can automatically lower the lifting mechanism 7 so far that the tool 11 is out of engagement with the ceiling 3.

In one exemplary embodiment the propeller 101 also create an additional torque to compensate the oscillation caused by working process in the machining mode S4. Preferably, the propeller 101 is rigidly connected to the lifting mechanism 7, for example, the side of the top of the lifting mechanism 7. Due to disturbances of the equilibrium, the lifting mechanism 7 can oscillate several times about the vertical alignment in response to the control process. The propeller 101 creates an additional torque to the wheels. The torque acting on the lifting mechanism 7 is opposed by the additional torque acting on the wheels 27. The oscillating of the lifting mechanism 7 is damped by the additional self-balancing member 100, that is, propeller 101.

The user can now move the tool guide 1 to a next marked position 4. The user switches the tool guide 1 into the driving mode S1. The control station 22 is locked for the user. The hand-held machine tool 6 is forcibly turned off. The tool guide 1 can check before starting whether the tool 11 is still in engagement with the ceiling 3. For example, the steering system 20 moves the chassis 8 by a small predetermined distance in a direction 26 and checks whether a counteracting torque acts on the chassis 8. The steering system 20 moves the chassis 8 back to the previous position 4, changes to the standing mode and causes the control station 22 to lower the lifting mechanism 7.

The chassis 8 is the first self-balancing system for the tool guide 1. The chassis 8 has two wheels 27 coupled with the drive 21. The two wheels 27 are mounted mutually offset on a transverse axis or wheel axle 28. The wheel axle 28 extends through the middle of the two wheels 27. The wheels 27 may be parallel to each other; or the wheels 27 are inclined by a few degrees to each other due to a camber and/or a toe angle. The two wheels 27 essentially rotate about the wheel axle 28. Each of the wheels 27 is coupled to the drive 21. The drive 21 may include two electric motors 29, for example. The wheels 27 each sit directly on a rotor 30, one of the electric motors 29. Alternatively, the wheels 27 may be coupled via clutches and gears to a central electric motor 29. The drive 21 exerts on the wheels 27 a torque acting around the wheel axle 28. The rotationally driven wheels 27 move the chassis 8 over the ground 19. The chassis 8 moves straight ahead when the two wheels 27 rotate at the same speed. The wheels 27 can be driven individually by the drive 21. Different torque and different speed of the wheels 27 cause the chassis 8 to drive around a bend. Preferably, the wheels 27 can be driven in opposite directions to rotate the chassis 8 about its vertical axis. The drive 21 receives control signals for speed and torque of the two wheels 27 from the steering system 20. The steering system 20 generates the control signals in response to predetermined steering movements, e.g., to the steering movements specified by the user.

The propeller 101 is an exemplary embodiment of the additional self-balancing member 100, which works together with the self-balancing chassis to achieve an improved controllability of the accuracy of positioning and speed. The propeller 101 may have a sensor for detecting the output torque and speed of the wheels 27. The acquired measurement data can be transmitted to the propeller 101 in order to correct the deviations from the steering movement of the chassis 8.

The chassis 8 and the tool guide 1 are on the floor 19 only with the two wheels 27. The two points of contact P1 P2 are on a line parallel to the wheel axle 28. For a statically stable state, there is no third point of contact with the ground 19 outside the line. The tool guide 1 would fall over without a countermeasure. The additional self-balancing member 10 help the steering system 20 achieve a dynamic equilibrium by permanently balancing the center of gravity G of the lifting mechanism 7. Based on detection of the center of gravity G, the propeller 101 generates a counteracting torque acting on the wheels to correct the deflection or deviation.

The lifting mechanism 7 is mounted on the chassis 8. The lifting mechanism 7 is stationary relative to the chassis 8, in particular, the lifting mechanism 7 is immovable with respect to the drive 21 and the wheel axle 28. The lifting mechanism 7 is preferably rigidly connected to a stator 31 of the drive 21. The drive 21 generates a torque and a retroactive torque of the same size and opposite direction of rotation in pairs. The torque acts on the wheels 27 via the rotor 30 of the drive 21. The retroactive torque acts via the stator 31 of the drive 21 on the lifting mechanism 7.

The weight of the tool guide 1 is composed of the weight of the chassis 8 and the weight of the lifting mechanism 7 together. The weight of the hand-held machine tool 6 and the propeller 101 is, to simplify, added to the weight of the lifting mechanism 7. The center of gravity of the chassis 8 is approximately on the wheel axle 28. The wheels 27 the drive 21 and batteries 32 are mounted symmetrically about the wheel axle 28. The center of gravity G of the lifting mechanism 7 is above the wheel axle 28. The tool guide 1 stands, albeit only metastable, if the center of gravity G is vertically above the wheel axle 28 (equilibrium, FIG. 5). A lateral deflection x is equal to zero. The tool guide 1 falls when the center of gravity G is offset from the wheel axle 28 in the lateral direction 33, i.e., the lateral deflection x is not equal to zero (FIG. 6).

Both the steering system 20 and the propeller 101 have a (center of gravity) sensor 34 for detecting the lateral deflection x of the center of gravity G of the lifting mechanism 7. The lateral deflection x of the center of gravity G out of equilibrium results in various measurable variables. The lifting mechanism 7 is inclined to gravity; the center of gravity sensor 34 may accordingly include an inclination sensor. The falling movement leads to a characteristic acceleration; the center of gravity sensor 34 may include a gyro sensor, an acceleration sensor, a yaw rate sensor, etc. for determining speed, acceleration, yaw rate and/or rotational movement about the wheel axle 28. The inclined lifting mechanism 7 exerts a torque on the drive 21; the center of gravity sensor 34 may include a torque sensor, a force sensor, etc. for detecting a torque, a non-vertical force, etc. The sensors can detect the quantities listed above based on mechanical, optical, magnetic or electrical effects.

The steering system 20 and the propeller 101 work together to determine a torque for erecting the lifting mechanism 7 based on the deflection x. For example, the steering system 20 may specify a torque proportional to the deflection x. The steering system 20 transmits the torque in the form of a control signal to the drive 21 which generates the torque. At the same time, the propeller 101 also calculates the target additional torque which is needed to compensate the torque generated by the drive 21. The steering system 20 and the propeller forms a control loop that adjusts the deflection x to zero. Control parameters, such as the gain factor and the integral component, are preferably adaptable, for example, in order to adapt the target additional torque generated by propeller 101 to the different weight of the hand-held machine tools 6.

The lifting mechanism 7 is vertically aligned by the engine power of the drive 21. Due to disturbances of the equilibrium, the lifting mechanism 7 can oscillate several times about the vertical alignment in response to the control process. At this moments, the propeller 101 creates an additional torque for counteracting the oscillation. After oscillating, no movement is visible to the user. The torque acting on the lifting mechanism 7 is opposed by the additional torque acting on the wheels 27.

The statically unstable position of the chassis 8 and the additional self-balancing members are used to align the lifting axis 25 vertically. In the dynamic equilibrium, the center of gravity G lies vertically above the wheel axle 28. The lifting mechanism 7 is, relative to the wheel axle 28, mounted such that a line passing through the center of gravity G and the working axis 18, is parallel to the lifting axis 25. The exemplary lifting mechanism 7 has a balance weight 35 on the mounting 5 to adjust the position 4 of the center of gravity G for different hand-held machine tools 6. The balance weight 35 can be locked at different distances from the lifting axis 25. Instead of a balance weight 35, the control can adjust the deflection x to a predetermined offset. The offset preferably takes into account the placing position of the lifting mechanism 7. Regardless of the height of the lift 7, the dynamic balancing aligns the lifting axis 25 vertically.

Preferably, in the dynamic equilibrium, if the center of gravity G lies a bit forwardly above the wheel axle 28, the tool guide 1 can move faster due to the forward force. But it is important to keep the whole tool guide balancing, the forward offset should not be too much, otherwise the tool guide 1 falls over to the ground. The propeller 101 can excellently control the dynamic equilibrium. The user activates the tool guide 1. The controller 9 activates the propeller 101 of the tool guide 1. The propeller blades rotate and generate a pulling force, which leads to an torque on the upper portion of the tool guide 1, thereby causing the center of gravity G of the lifting mechanism to deflect a bit from the vertical axis, that is, a deflection x is not zero at this moment. Such a deflection would help the tool guide tend to move forwardly. Since the additional torque on the top enables the tool guide 1 to lean fast in a desired direction, the propeller 101 accelerates the tool guide's movement in a desired direction. The propeller 101 needs to calculate the correct target torque which is needed to move forward, and at the same time, the tool guide 1 would not fall over the ground. Direction and speed of movement of the chassis 8 are additionally controlled by the propeller 101 of the tool guide 1. It is useful to improves the accuracy of speed and position.

In one exemplary embodiment, the additional self-balancing member 100 is a moving mass 102, which is arranged between the mounting 5 and lifting mechanism 7. The moving mass 102 can move along the lifting axis 25. Depending on the position of the moving mass 102, it can create a target torque exerting on the wheels for additional balancing the tool guide in the correct position.

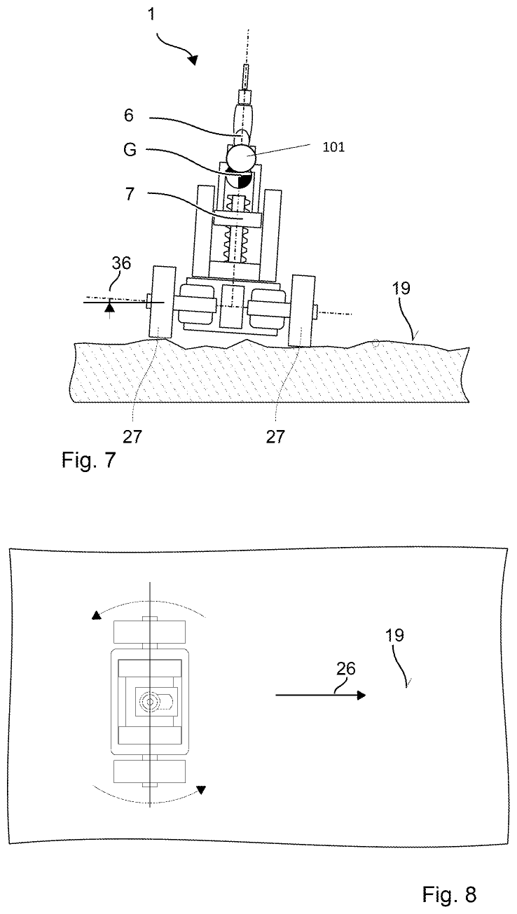

The dynamic balancing ensures a vertical alignment when the wheel axle 28 is horizontal. The deflection x is in a level perpendicular to the direction of the wheel axle 28. For an uneven floor 19 or inclined floor 19, the wheel axle 28 may be inclined to the horizontal plane (FIG. 7). The inclination 36 of the wheel axle 28 translates into a similar inclination of the lifting mechanism 7. The inclination 36 is in a plane which is spanned by the wheel axle 28 and the vertical axis. The inclination of the wheel axle 28 cannot be directly compensated by the dynamic balancing.

For machining the ceiling 3, the inclination 36 is preferably also compensated. The exemplary controller 9 provides for triggering the inclination 36 when activating the lifting mode S3. The user or an external controller 9 will activate the lifting mode S3 when the tool guide 1 is positioned at the predetermined position 4. The compensation can also be triggered in another mode. For example, a specific mode for the compensation can be provided, which is triggered automatically or on request of the user, for example, when reaching the position 4.

It is advantageous to use the additional self-balancing member 100 to compensate such an inclination 36. Preferably, the additional self-balancing member 100 is a moving mass 102. More preferably, the additional self-balancing member 100 is compressed air 103. The alignment therefore initially provides for setting the two wheels 27 to the same height. The tool guide 1 rotates about a vertical axis, which coincides, for example, with the working axis 18. The vertical axis denotes an axis which is perpendicular to the wheel axle 28 and extends substantially along the vertical axis. The tool guide 1 is preferably positioned so that the vertical axis passes through the predetermined position 4. The moving mass 102 or the compressed air 103 created an additional torque acting on the two wheels 27, which rotates the two wheels at the same speed in the opposite direction 26, as shown in FIG. 8. The tool guide 1 and the tool 11 thus remain at the same position 4. The compact design with the small footprint typically allows this rotation even in confined spaces. The rotation takes place until the inclination 36 of the wheel axle 28 is equal to zero. Since the tool guide 1 touches the bottom 19 with only two wheels 27, for each position 4 there are at least one location in which all wheels 27 are at the same height. An inclination sensor 37 can detect the inclination of the wheel axle 28 with respect to the horizontal plane. The inclination sensor 37 can be implemented, for example, by the center of gravity sensor 34 or analogously. The moving mass 102 or the compress air 103 balances the lifting mechanism 7 in the vertical lateral direction 26 of the wheel axle 28. The additional torque generated by the moving mass 102 or the compressed air 103 exerting on the two wheels 27 acts in the same direction 26 and is typically the same size.

The additional self-balancing member 100 can work as a complementary system to the steering system 20. For example, the steering system includes a console 10 with input elements for driving direction and speed. An exemplary console 10 is based on a two-axis joystick. Other consoles may include, for example, a steering wheel for the direction of travel and a slider for the speed. The console 10 is preferably removable from the tool guide 1. A transmission of the control signals generated by the console 10 to the drive 21 is radio-based, optical or cable-based. The steering system 20 can detect a pushing or pulling force exerted by the user on the chassis 8. Under the action of the force, the propeller 101 creates an additional force and cause the chassis 8 to tilt in the direction 26 of the pushing or pulling force. The steering system 20 and the propeller 101 detects the deflection x of the chassis 8. A speed of the chassis 8, for example, may be proportional to the deflection x.

In one embodiment, the tool guide 1 may suspend dynamic balancing when the tool 11 touches the ceiling 3. With the contact point on the ceiling 3, the tool guide 1 can remain static. The tool guide 1 can change to a stop mode S5, in which the wheels 27 are blocked by a brake 53 (FIG. 9). The balancing and the associated slight oscillating movement stops.

The tool guide 1 has a (contact) sensor 54 which detects a contact with the ceiling 3. Typically, the tool 11 consumables or the hand-held machine tool 6 touches the ceiling 3. The mounting 5 indirectly touches the ceiling 3. The contact sensor 54 outputs a (contact) signal to the controller 9, in which it is coded whether the tool 11 is in contact with the ceiling 3. The contact sensor 54 can evaluate, for example, the contact pressure of the lifting mechanism 7 or a measure of the contact pressure. The contact sensor 54 reports a contact when the contact pressure exceeds a threshold value or a rate of change of the contact pressure exceeds a threshold value. The threshold value is preferably dimensioned such that the associated contact pressure force is sufficient to keep the tool guide 1 in a static stable state via the two wheels 27 and the contact point on the ceiling 3. The contact sensor 54 may be realized for example by the sensor 49 or an analog sensor 49.

The controller 9 preferably suspends the balancing of the chassis 8 in case a contact signal is present. The controller 9 can delay the suspension until the contact signal is present for a minimum period. When the contact signal is present, the steering system 20 checks whether the lifting mechanism 7 is vertically aligned. If the steering system 20 detects a deviation from the vertical orientation, the propeller 101 is activated to apply an additional torque that adjusts the deflection x to zero, ensuring that the lifting mechanism 7 is vertically aligned.

The chassis 8 preferably has a brake 53. The brake 53 is preferably activated as soon as the tool guide 1 is vertically aligned and the contact signal is applied. The brake 53 is a parking brake, which permanently blocks the wheels 27 of the chassis 8.

The tool guide 1 has one or several batteries 32, 55 for supplying electricity. The tool guide 1 falls into an (emergency) mode S9 when the battery level 32 55 falls below the emergency level. The emergency mode ensures a secure position of the tool guide 1. The chassis 8 and the propeller 101 are supplied with power. The user can drive the tool guide 1 to a charging station or another desired location.

1.-10. (canceled)

11. A self-aligning tool guide, comprising:
a mounting for fixing a hand-held machine tool;
a lifting mechanism, wherein the mounting is mounted on the lifting mechanism and wherein the lifting mechanism has a propulsion unit for lifting the mounting parallel to a lifting axis;
a self-balancing chassis, wherein the self-balancing chassis has two wheels on a wheel axle, a drive coupled with the two wheels, and a steering system;
a center of gravity sensor, wherein a lateral deflection of a center of gravity of the lifting mechanism relative to the wheel axle is detectable by the center of gravity sensor and wherein the steering system is configured to control the drive to output a torque counteracting the lateral deflection; and
a self-balancing member mounted on an upper portion of the self-aligning tool guide, wherein the self-balancing member delivers an additional torque for balancing the self-aligning tool guide.

12. The self-aligning tool guide according to claim 11, wherein the self-balancing member calculates the additional torque for counteracting the lateral deflection complementarily.

13. The self-aligning tool guide according to claim 12, wherein the self-balancing member creates the additional torque and delivers the additional torque to the two wheels.

14. The self-aligning tool guide according to claim 13, wherein a movement of the self-aligning tool guide in a direction is acceleratable by the additional torque created by the self-balancing member.

15. The self-aligning tool guide according to claim 13, wherein the self-aligning tool guide is holdable in an upright position by the additional torque created by the self-balancing member.

16. The self-aligning tool guide according to claim 11, wherein the self-balancing member is a propeller.

17. The self-aligning tool guide according to claim 11, wherein the self-balancing member is a moving mass.

18. The self-aligning tool guide according to claim 11, wherein the self-balancing member is compressed air.

19. The self-aligning tool guide according to claim 11, wherein the self-balancing member is mounted between the mounting and the lifting mechanism.

20. The self-aligning tool guide according to claim 11, wherein the lifting mechanism is limited to a single-axis, translational movement along the lifting axis.
